(19) United States
(12) Patent Application Publication
(10) Pub. No.: US 2013/0283363 A1
(43) Pub. Date: Oct. 24, 2013

(54) SECURE DATA TRANSFER OVER AN ARBITRARY PUBLIC OR PRIVATE TRANSPORT

(71) Applicant: NXGEN SOFTWARE, LLC, Fort Lauderdale, FL (US)

(72) Inventors: Lee Howard Rautenberg, Boca Raton, FL (US); Joseph Vincent Niosi, Woodbury, NY (US)

(73) Assignee: NxGen Software, LLC, Fort Lauderdale, FL (US)

(21) Appl. No.: 13/865,255

(22) Filed: Apr. 18, 2013

Related U.S. Application Data
(60) Provisional application No. 61/635,466, filed on Apr. 19, 2012.

(51) Int. Cl. G06F 21/31

(52) U.S. Cl. CPC G06F 21/31
USPC 726/7

(57) ABSTRACT

A method, system, and computer program product for transferring data between endpoint devices is provided. The method includes determining a send pattern utilizing account credentials of a user. The send pattern defines a plurality of offset and length pairs. The method further includes creating packets of data according to the send pattern. Each packet of data contains randomly assigned data of different sizes. The method also includes encrypting each packet of data to produce a set of encrypted packets of data and sending the set of encrypted packets of data to a destination endpoint device in an order determined according to the account credentials.

### CROSS-REFERENCE TO RELATED APPLICATIONS

This application claims priority to U.S. Application No. 61/635,466, entitled “Secure Data Transfer Over an Arbitrary Public or Private Transport,” filed on Apr. 19, 2012, which is herein incorporated by reference in its entirety.

### BACKGROUND OF THE INVENTION

1. Field of the Invention

The present invention relates to data transfers, and more particularly, to the secure transfer of data.

2. Description of the Related Art

In the simplest of terms, the transfer of data involves sending data from one point to a different point. For data that contains confidential or proprietary information, it is desirable to transfer the data in such a way to ensure the data is not susceptible to eavesdropping or interception by a person who accesses a computer by circumventing its security (“a hacker”). Known solutions for transferring secure data include basing an entire security model on a single standard encryption technique, transferring data securely with a “secure” or “semi-secure” transport, such as Hypertext Transfer Protocol Secure (HTTPS), Secure Sockets Layer (SSL), and Secure File Transfer Protocol (SFTP, or requiring special hardware or software, for instance requiring a specific port to be open before allowing the transfer of data. (As used herein, the term “semi-secure” refers to standard protocols (e.g., HTTPS, SSL, SFTP, and others in common use).) Further, the transfer of data typically requires an intermediate device, such as a server, which stores the data during transport.

But these solutions have their limitations. Requiring special ports requires complex or special hardware and/or software configurations. Further, there are known issues with basing an entire security model on a single standard encryption technique and transferring data securely over unsecure transports, including the ability of a hacker to intercept confidential or proprietary data whether during transport or at the sending or receiving device. For example, a hacker can steal the source code used to implement a data transfer so as to acquire the ability to reassemble the transferred data; a hacker can directly access the servers or the data (in databases) itself in order to obtain and view the data; and, a hacker can gain access to the data during transport, such as in man-in-the-middle attacks.

Also, supposedly secure transports, such as HTTPS/SSL, SFTP, are not secure, as these transports continue to be hacked. In addition, storing large portions of the data during transport on a server or, even, storing the data intact on another medium, such as “in the cloud,” leaves open these devices for being hacked. Therefore, a method for transferring data securely using inherently insecure transports that eliminates potential points of attack by a hacker as well as simplifies the requirements of complex hardware and software assisted transports are needed.

### BRIEF SUMMARY OF THE INVENTION

Embodiments of the present invention address deficiencies of the art with respect to securely transferring data and provide a novel and non-obvious method, system, and computer program product for transferring data between endpoint devices. In an embodiment of the invention, a method for securely transferring data between endpoint devices is provided and can include determining a send pattern utilizing account credentials of a user with the send pattern defining a plurality of offset and length pairs. The method can further include creating packets of data according to the send pattern, where each packet of data can contain randomly assigned data of different sizes. The method can even further include encrypting each packet of data to produce a set of encrypted packets of data and sending the set of encrypted packets of data to a destination endpoint device in an order determined according to the account credentials.

Another embodiment of the invention provides for a data processing system configured for processing data for transfer between endpoint devices. The system can include a server coupled to multiple, different endpoint devices, such as a destination endpoint device and an originating endpoint device. Both the server and the endpoint devices can be further configured to support a data transfer module. The data transfer module can include program code for determining a send pattern utilizing account credentials of a user with the send pattern defining a plurality of offset and length pairs and for creating packets of data according to the send pattern with each packet of data containing randomly assigned data of different sizes. The data transfer module can further include program code for encrypting each packet of data to produce a set of encrypted packets of data and sending the set of encrypted packets of data to the destination endpoint device in an order determined according to the account credentials.

In yet another embodiment of the invention, a method for securely transferring data between endpoint devices is provided and can include receiving a set of encrypted packets of data from an originating endpoint device in an order determined according to account credentials of a user with each encrypted packet of data containing randomly assigned data of different sizes. The method can further include decrypting the set of encrypted packets of data using the account credentials of the user to produce a set of decrypted packets of data and reassembling the set of decrypted packets of data to form a data message according to a send pattern utilizing account credentials of the users with the send pattern defining a plurality of offset and length pairs.

In event yet another embodiment of the invention provides for a data processing system configured for receiving data between endpoint devices. The system can include a server coupled to multiple, different endpoint devices, such a destination endpoint device and an originating endpoint device. Both the server and the endpoint devices can be further configured to support a data transfer module. The data transfer module can include program code for receiving a set of encrypted packets of data from the originating endpoint device in an order determined according to account credentials of a user with each encrypted packet of data containing randomly assigned data of different sizes. The data transfer module can further include program code for decrypting the set of encrypted packets of data using the account credentials of the user to produce a set of decrypted packets of data and reassembling the set of decrypted packets of data to form a data message according to a send pattern utilizing account credentials of the users with the send pattern defining a plurality of offset and length pairs.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of this specification, illustrate embodiments of the invention and together with the description, serve to explain the principles of the invention. The embodiments illustrated herein are presently preferred; it being understood, however, that the invention is not limited to the precise arrangements and instrumentalities shown, wherein:

FIG. 1 is a pictorial illustration of a process for transferring data between computing devices;

FIG. 2 is a schematic illustration of a data processing system configured for transferring data between endpoint devices;

FIG. 3A is a flow chart illustrating a process for validating the devices of an end user; and,

FIG. 3B is a flow chart illustrating a process for obtaining data between validated endpoint devices.

### DETAILED DESCRIPTION OF THE INVENTION

Embodiments of the invention provide for secure data transfer between endpoint devices. In secure data transfer, after a “sending” endpoint device receives a request for data from a “receiving” endpoint device, the “sending” endpoint device can determine a send pattern based upon the account credentials of a user. The send pattern can consist of a random collection of offset and length pairs that determine the sequence in which a number of “chunks” of data will be sent. Further, the account credentials can be used as encryption keys to encrypt each “chunk” using a randomly selected encryption method. After each “chunk” has been, optionally, compressed and encrypted, each chunk can be sent to the “receiving” endpoint device according to an order again based upon the account credentials. The “receiving” endpoint device can then use the same account credentials in order to decrypt, decompress, and reassemble the data. In this way, each endpoint device uses the account credentials of the user to encode and decode data being transferred between the devices. Therefore, a hacker is unable to reassemble the data being transferred even if the hacker intercepts the data, because the hacker does not know the account credentials used as the basis for determining the size of each “chunk,” the encryption used, and the order each “chunk” as required to decrypt and reassemble the data.

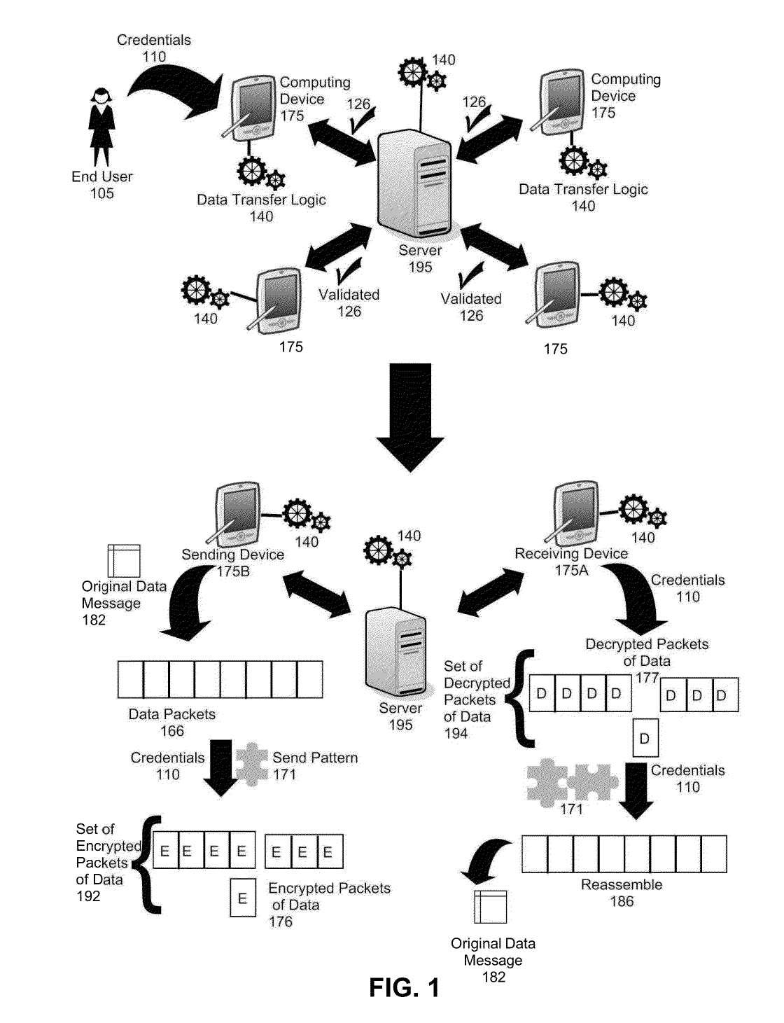

In further illustration, FIG. 1 pictorially shows a process for transferring data between computing devices. As shown in FIG. 1, an end user 105 can log into a server 195 from a computing device 175 using her credentials 110. The end user 105 can use any computing device 175 to log into the server 195. The computing device 175 can be any type of endpoint device, including but not limited to servers, desktop computers, laptop computer, tablets, smart phones, and personal digital assistants. Of note, a user's credentials 110 (or account credentials) can be any identifier, such as a username, and/or password that uniquely identifies the end user 105 from other users. The credentials 110 can also include other static information unique to the device, such as hardware serial numbers. Further, the credentials can be encrypted. Data transfer logic 140 on the computing device 175 can use the credentials 110 as encryption key seeds to create a one-way security token that can be validated 126 by data transfer logic 140 on the server 195. As used herein “seeding” refers to using the credentials 110 of an end user 105 as the starting point in an algorithm where the algorithm determines such items as determining different sized data packets, how the data is assigned to the data packets, with what encryption scheme (which includes an optional, random compression technique) are used to encrypt the data packets, the number of data packets to send at a time, and the order the data packets will be sent. Of note, in addition to using the credentials 110 of a user, other information, such as hardware serial numbers (media access control (MAC) addresses, time of day, number of seconds since Jan. 1, 2000 as determined at midnight, etc. can also be used for seeding. Once all the computing devices 175 of the end user 105 have been validated 126 by the server 195, the validated computing devices 175 can be each assigned a session token. The validated computing devices can then, using data transfer logic 140, exchange various messages that have been encrypted using encryption keys that were generated based on credentials 110 of the end user 105.

When a computing device 175 wants to obtain data (an original data message 182) from another computing device 175, data transfer logic 140 on a receiving (or destination) device 175A can send a message to be proxied by the server 195 to the sending (or originating) device 175B. Of note, it is contemplated that once the computing devices 175A have been validated and each computing device 175A has been assigned a session token, the receiving device 175A can send a message requesting data to the sending device 175B directly without requiring the message to be proxied by the server 195. The data may be any sequence of bytes known by the sender in advance of the data transfer between endpoint devices. Further, the data can reside in a physical file or it may be memory bound content known only to the application feeding the data to the sending device's “engine” (data transfer module). Once the request for data is received by the sending device 175B, data transfer logic 140 can determine a send pattern 171 utilizing the account credentials 110 of the user 105 for the exchange of data. Of note, the send pattern 171 can also be determined using other information, such as MAC addresses, time of day, number of microseconds past midnight, etc., in addition to the account credentials 110 of the user 105. The send pattern 171 consists of a random collection of offset and length pairs that determine the sequence in which random data packets 166 or chunks of data will be sent to the receiving device 175A. The send pattern 171 can also indicate the compression to be used as well as the order the chunks of data will be sent.

Once packets of data 166 containing randomly assigned data of different sizes are created, data transfer logic 140 on the sending device 175B can individually encrypt each data packet 166 to produce a set of encrypted packets of data 192. Optionally, data transfer logic 140 on the sending device 175B can compress each packet of data 166 or the set of encrypted packets of data 192 prior to sending the set of encrypted packets of data 192 to the receiving device 175A as compression can be performed before or after encryption. In addition, each data packet 166 can contain information related to the offset and length pairs. Encryption of the data packets 166 can be performed using an algorithm that is seeded with account-wide encryption keys based on the credentials 110 of the end user 105.

Data transfer logic 140 on the sending device 175B can send the now encrypted packets of data 176 as a set of encrypted packets of data 192 to the receiving device 175A via the server 195 over any transport network. Of note, though FIG. 1 illustrates a server 195, a server 195 is not required for transporting the set of encrypted packets of data 192 from the sending device 175B to the receiving device 175A once the endpoint devices 175A, 175B have been validated and assigned a session token by the server 195. More specifically, the set of encrypted packets of data 192 can be sent by data transfer logic 140 from the sending device 175B to the receiving device 175A via a peer-to-peer computer network, thus eliminating the need for the server 195. Regardless of whether or nor a server 195 is used in the process of transferring data between endpoint devices, the encrypted packets of data 176 can be sent by data transfer logic 140 in an order determined according to the credentials 110.

In the instances where a server 195 is used during the transfer of data, the server 195 has no knowledge of what is in the set of encrypted packets of data 192, and the server 195 knows only to which computing device 175 the set of encrypted packets of data 192 are to be sent. Once the receiving device 175A receives the set of encrypted packets of data 192 forwarded by data transfer logic 140 on the server 195, data transfer logic 140 on the receiving device 175A can put the encrypted packets of data 176 back together to reform the entire data message.

Specifically, data transfer logic 140 on the receiving device 175A can receive the set of encrypted packets of data 192 from the sending device 175B via the server 195 in an order determined according to the credentials 110 of the user 105 and/or based upon other information selected by data transfer logic 140, such as the MAC address of the sending device 175B, time of day, number of seconds past a certain point of time, etc. Of note, in the instances when there is no server 195 being utilized in the data transfer, data transfer logic 140 on the receiving device 175A can receive the set of encrypted packets of data 192 directly from the sending device 175B in an order determined according to the credentials 110 of the user 105 as well as other information. Further, data transfer logic 140 on the receiving device 175A can decrypt the set of encrypted packets of data 192 using the credentials 110 of the user 105 to produce a set of decrypted packets of data 194 of decrypted packets of data 177. Further, data transfer logic 140 on the receiving device 175A can decompress the set of encrypted packets of data 192 or the set of decrypted packets of data 194, as the decompression can occur before or after decryption. In addition, data transfer logic 140 on the receiving device 175A can reassemble 186 the decrypted set of packets of data 194 so that each decrypted packet of data 177 can be fitted back together to form the (original) data message 182. The reassemble 186 of the decrypted set of data packets 194 can be accomplished according to the offset and length pairs of the send pattern 171. In other words, data transfer logic 140 on the receiving device 175A can use a decryption algorithm that is based upon the same credentials 110 of the end user 105. In this way data can be transported through any public medium and can still be secure.

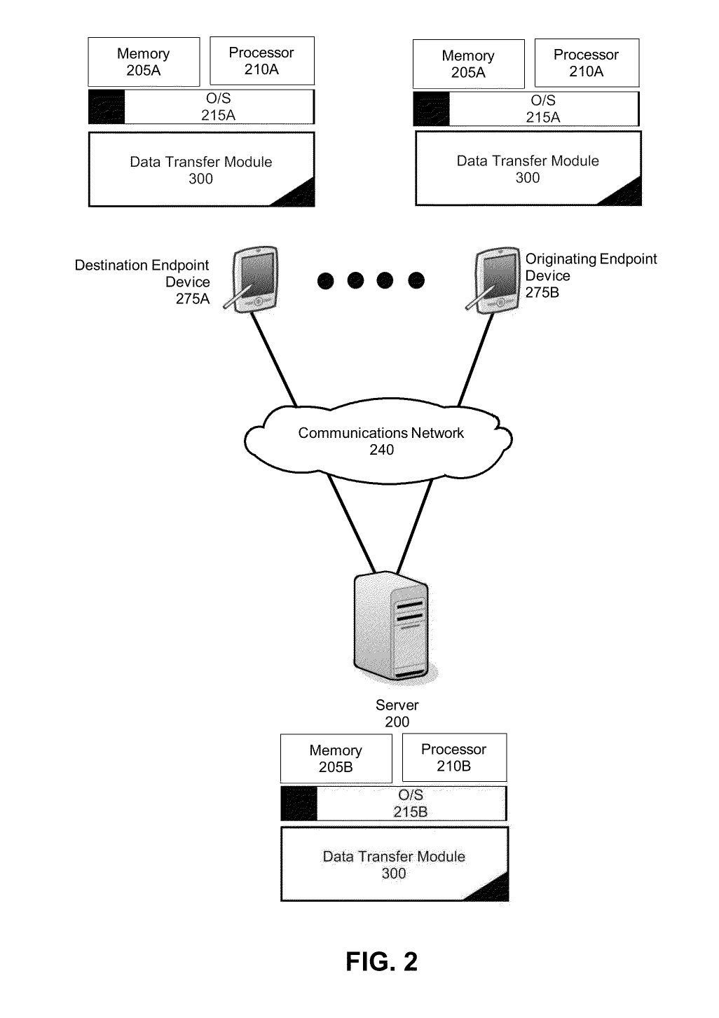

The process described in connection with FIG. 1 can be implemented in a data processing system configured for transferring data between endpoint devices. In further illustration, FIG. 2 is a schematic illustration of a data processing system configured for transferring data between endpoint devices. The system can include a server 200 with memory 205B and at least one processor 210B supporting the execution of an operating system (O/S) 215B. The O/S 215B in turn can support a data transfer module 300. The server 200 can be coupled to multiple, different endpoint devices, 275A, 275B, for instance a destination endpoint device and an originating device. The server 200 can communicate with the endpoint devices 275A, 275B via a transport or communications network 240. The communications network 240 is not limited to a specific communications technique and can include Internet, intranet, wireless communications, Ethernet, 3G, 4G, or other network. Each endpoint device 275A, 275B can include memory 205A and at least one processor 210A supporting the execution of an operating system (O/S) 215A. Further, the operating system 215A of each endpoint device 275A, 275B can support the data transfer module 300.

The data transfer module 300, which can execute in memory 205A, 205B of the server 200 and each endpoint device 275A, 275B, can include program code which, when executed, on the server 200 can assign a session token to all endpoint devices 275A, 275B that have been validated. In an embodiment, the program code of the module 300 on the server 200 can validate each endpoint device 275A, 275B by validating one-way security tokens created by the module 300 on each endpoint device 275A, 275B. The one-way security tokens, in one instance, can be created by the data transfer module 300 on each endpoint device 275A, 275B using credentials of an end user. Specifically, the credentials can be used as encryption key seeds. The credentials can be used by an end user to log into the server 200 from any endpoint device 275A, 275B. Of note, locally available static information, such as hardware serial numbers, can also be used to save locally stored credentials. Once each endpoint device 275A, 275B within the account of an end user has been validated and assigned a session token, the program code of the data transfer module 300 on each endpoint device 275A, 275B can exchange various messages using encryption keys generated using the credentials of the user. In other words, upon logging onto the server 200, the server 200 (the program code of the data transfer module 300 on the server 200) can recognize the user's account and be able to transfer data between endpoint devices 275A, 275B associated solely with that user.

When an endpoint device 275A, 275B wants to obtain data from another endpoint device 275B, 275A, the program code of the data transfer module 300 on a “receiving” or destination endpoint device 275A, which can be configured to receive process data, can send a message to the server 200 coupled to the destination endpoint device 275A. The program code of the data transfer module 300 on the server 200 can receive the data request and forward the data request to a “sending” or originating endpoint device 275B, which can be configured to process and send the data being requested. Of note, in a different embodiment, once the originating endpoint device 275B and the destination endpoint device 275A have been validated and each device 275A, 275B assigned a session token, the program code of the data transfer module 300 on the destination endpoint device 275A can send a data request directly to the originating endpoint device 275B, thus bypassing the server 200.

Upon receiving the data request, the program code of the data transfer module 300 on the originating endpoint device 275B can break the data (or data message) up into “chunks” or packets (of data), according to a send pattern. Further, each chunk can have different sizes, and such sizes can be randomly assigned to data in accordance with an algorithm. Of note, the algorithm can be seeded using credentials of a user or other information, based upon such items as the MAC address of the originating endpoint device 275B, the time of day, the number of minutes passed noon, etc. Of further note, it is the algorithm that is used to create the send pattern. The send pattern can define a plurality of offset and length pairs as well as identify the compression to be utilized for each packet of data and the order the set of encrypted packets of data are sent.

Once the data has been chunked into randomly sized packets, program code of the data transfer module 300 on the originating endpoint device 275B can subject each packet to an encryption scheme, which is also randomized, to produce a set of encrypted packets of data. Optionally, the program code of the module 300 on the originating endpoint device 275B can compress the data packets either before or after encryption. The set of randomly sized and randomly encrypted packets of data can be sent to the server 200 by the program code of the data transfer module 300 on the originating endpoint device 275B via the communications network 240. Further, the set of randomly sized and randomly encrypted packets of data can be sent by the program code of the data transfer module 300 in a non-specific, random order. In other words, the set of randomly sized and randomly encrypted packets of data can be sent in an order determined according to the credentials of the user whose validated endpoint devices 275A, 275B are involved in the transfer of data. It is noted that in addition to the credentials of the users other information specific to the endpoint devices 275A, 275B, such as MAC address, time of day, number of microseconds past midnight, etc., can be used to determine the order the randomly sized and randomly encrypted packets of data are sent. The program code of the data transfer module 300 on the server 200 can forward the data to the destination endpoint device 275A.

The program code of the data transfer module 300 on the destination endpoint device 275A can decrypt the randomly sized and randomly encrypted packets of data to produce a set of decrypted packets of data using a decryption algorithm that was seeded using the same credentials that created the encrypted packets of data upon receiving the set of randomly sized and randomly encrypted packets of data from the originating endpoint device 275B. Further, if the set of encrypted packets of data was compressed prior to being transferred, the program code of the data transfer module 300 on the destination endpoint device 275A can decompress the packets before or after decryption. Even further, the program code of the data transfer module 300 on the destination endpoint device 275A can reassemble the decrypted set of packets of data to form the original data message according to the send pattern so to recreate the entire data message. As on the originating endpoint device 275B, the send pattern utilizes the credentials of the user to determine a plurality of offset and length pairs.

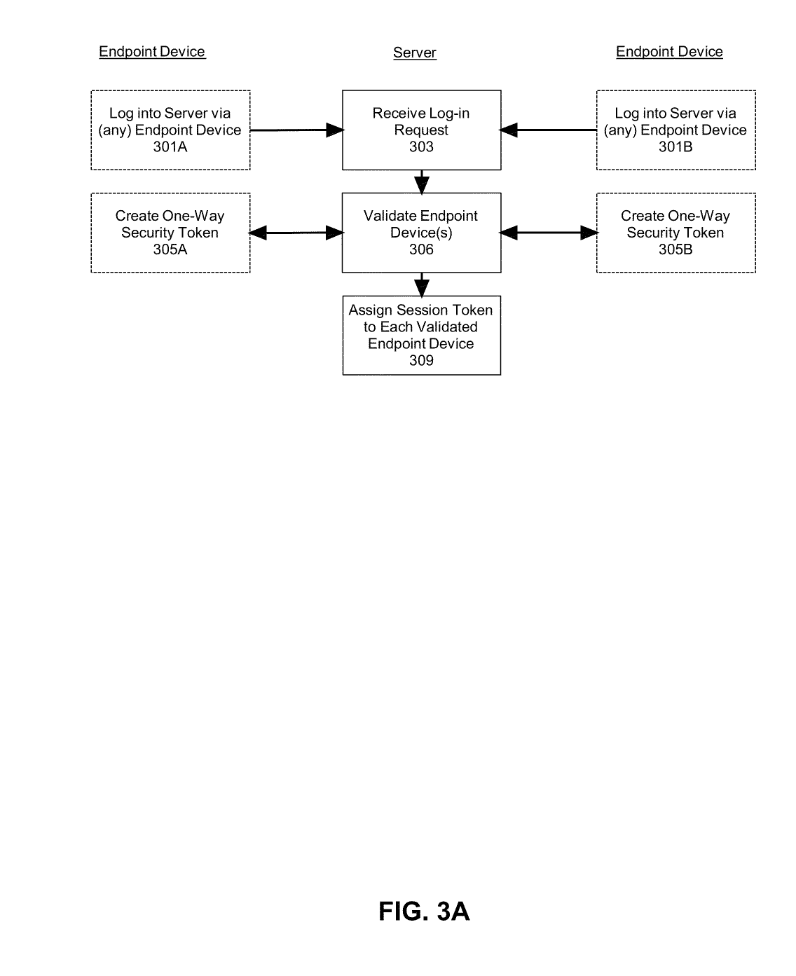

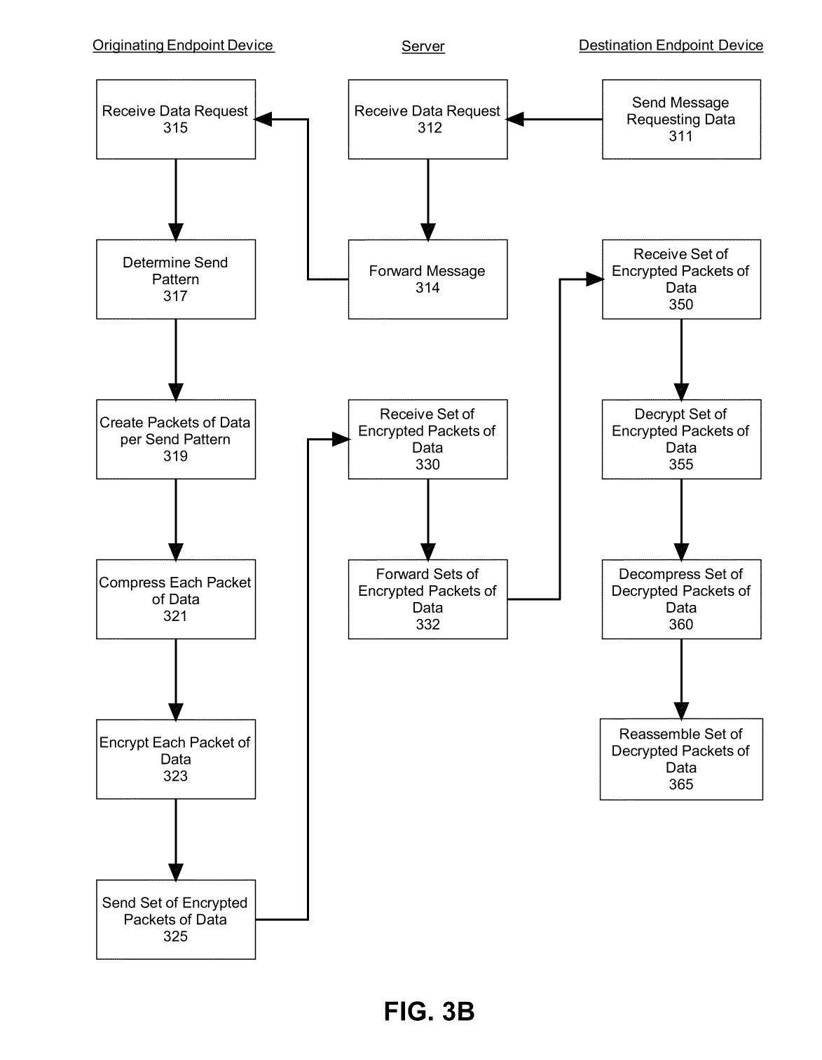

In yet further illustration of the operation of the data transfer module, FIG. 3A is a flow chart illustrating a process for validating the devices of an end user. Beginning in block 301A, 301B, a user can log into any endpoint device using her account credentials (or just credentials), such as a username and a password, that uniquely corresponds with the user. The data transfer module on the server can then receive the log-in request, as shown in block 303, and can validate any endpoint device associated with the user, as illustrated in block 306. In an embodiment, a user can identify each endpoint device as hers by logging into each endpoint device with her credentials, so each endpoint device is associated solely with a particular user's account. In order to validate each endpoint device, the module on the server can verify one-way security tokens created by the module on each endpoint device, as shown in block 305A, 305B. Of note, the one-way security token utilizes the credentials a user logged into the endpoint device. Specifically, the credentials are used as encryption key seeds to create the one-way security token. Of further note, each endpoint device of the user (each device within the account of the user) uses the same credentials to log into the server. After each end point device associated with the user is validated, the module on the server can assign a session token to each validated endpoint device, as illustrated in block 309. In this way, all validated endpoint devices with an assigned session token can exchange various messages using the process described in FIG. 3B.

In even further illustration of the operation of the data transfer module, FIG. 3B is a flow chart illustrating a process for obtaining data between validated endpoint devices. As is illustrated in block 311, a destination endpoint device (or just receiving device) that wants to obtain data from another endpoint device can send a message to a server requesting data. Of note, the message sent by the destination device requesting data can be an encrypted message. As shown in block 312, the server receives the data request and can forward the message requesting data to the originating endpoint device (or just sending device), as in block 314. Of note, in a different embodiment, once the endpoint devices have been validated and each device assigned a session token, the destination endpoint device can send a message requesting data, as shown in block 311, directly to the originating endpoint device, thus bypassing the server. Once the data request is received by the originating device, as shown in block 315, the originating device can determine a send pattern, as illustrated in block 317. The send pattern is used for the exchange of data.

Specifically, the send pattern consists of a random collection of offset and length pairs that will determine the sequence in which a random number of packets of data (chunks) will be sent to the receiving device. In addition, the send pattern can define the type of compression to be applied to each packet of data and the order the set of encrypted packets of data are send to the destination endpoint device. Further, the send pattern is created using the credentials of the user (the login credentials) to seed an algorithm that determines what the offset and length pairs will be. The send pattern, in addition to the credentials of the users, can also be based upon other information, such as the MAC address of the sending device (originating endpoint device), the time of day, the number of microseconds past midnight, etc. In other words, a send pattern, defined by a plurality of offset and length pairs, is determined by utilizing the account credentials of a user as well as other information.

Once the send pattern has been determined, packets of data can be created according to the send pattern, as illustrated in block 319. The send pattern can be created in such a way that the data is broken into chunks of data with such chunks having different sizes. Thus, the packets of data can be created according to the send pattern with each packet of data containing randomly assigned data of different sizes. Further, the different sized chunks can be randomly assigned to the data being chunked. Of further note, the data being chunked can be assigned to the different sized chunks according to an algorithm that is seeded based upon the credentials of the user. Once the data has been broken up into different packets of data based upon the send pattern, each packet of data can be optionally compressed, as shown in block 321. After optional compression, each randomly sized packet of data can be encrypted to produce a set of encrypted packets of data, as shown in block 323. Of note, the specific encryption scheme is not defined herein, but can be randomized. In an embodiment, the encryption scheme is randomized by using the credentials of the user to seed an algorithm, which determines the encryption scheme used. Of note, the compression can be performed before or after encryption, though it is shown in FIG. 3B as being performed before encryption. In addition, each packet of data can contain information related to the offset and length pairs.

Upon encryption, and optional compression, the set of encrypted packets of data can be sent from the originating endpoint device, as illustrated in block 325, over a communications network (transport network) to the server in an order determined according to the account credentials. In other words, the order in which the set of encrypted packets of data is sent can also be randomized, such that the first encrypted packet of data does not correspond to a beginning portion of the data (message) and the last encrypted packet of data does not contain an end portion of the data. In an embodiment, the server does not allow any encrypted packets of data to be stored on the server during the transfer of the encrypted packets of data. In a different embodiment, the server can permit a portion of encrypted packets of data to be saved in the memory of server. In this case, the program code of the module 300 can only send a limited number of encrypted packets of data at a time. In even a different embodiment, once each endpoint device has been validated and each endpoint device assigned a session token, the program code of the module 300 on the originating endpoint device can send the encrypted packets of data directly to the destination endpoint device, without the need to send the set of encrypted packets of data via a server. In other words, after validation of the endpoint devices, the endpoint devices can act as a peer-to-peer computer network in order to send the set of encrypted packets of data from one endpoint device to another endpoint device. The credentials of the user as well as additional information based upon the state of the originating endpoint device, such as the time of day, the number of seconds past midnight, etc. can again be used to seed an algorithm which determines, among other things, the order of how each encrypted packet of data is sent and the actually number of encrypted packets of data sent at a time.

As shown in block 330, after the set of encrypted packets of data is received by a server, each set of encrypted packets of data can be forwarded to the destination endpoint device, as in block 332. It is noted that the server has no knowledge of what is in the (encrypted) packets of data. The server knows only to which endpoint device (the destination endpoint device) the packets of data are to be sent. Optionally, the server can permit up to a threshold value of packets of data from the same data message to be saved temporarily in the memory of the server. By allowing only a certain number (threshold) of packets of data to be saved from the same data message on the server, the module prevents a meaningful portion of the data from being on any device besides the validated endpoint devices of the user.

Upon receiving the set of encrypted packets of data, as illustrated in block 350, whether from the server or from the originating endpoint device in an order determined according to the account credentials of a user each encrypted packet of data can be decrypted, as shown in block 355. As noted above, each encrypted packet of data can contain randomly assigned data of different sizes. The set of encrypted packets of data can be decrypted to produce a set of decrypted packets of data. As each endpoint device of a particular user is seeded with the same user credentials, a decryption algorithm on the destination endpoint device based upon the credentials decrypts the packets of data. In other words, each encrypted packet of data can be decrypted using the account credentials of the user upon receiving the encrypted packet of data at the destination endpoint device.

After decryption, the decrypted set of packets of data can be decompressed, if previously compressed, as illustrated in block 360. Of note, decompression, as shown in FIG. 3B, can occur after decryption, but decompression can also occur before decryption. Of further note, the receipt of the encrypted packets of data can be verified and the originating endpoint device can be notified by the destination endpoint device via the server that each packet of data has been received and verified.

The set of decrypted packets of data can then be reassembled, as in block 365 to form a data message (the original data the originating device chunked and transferred). Further, the set of decrypted packets of data is reassembled according to a send pattern utilizing account credentials of the user. As indicated herein, the send pattern defines a plurality of offset and length pairs. The send pattern can further identify the compression to be applied as well as the order the set of encrypted packets of data is sent. Though the specific compression are not defined herein, and are not limited to a specific set, the send pattern can identify which compression is to be applied to each encrypted packet of data. In this way, data can be securely transferred between endpoint devices without compromising the security of the data even if a hacker has access to all the data bytes flowing between the endpoint devices, the source code of the software implementing the data transfer, and access to any server databases used to access and/or facilitate inter-device transport. In addition, if there is any attempt to corrupt the data, the transfer of the data will be rejected, and the endpoint devices will be required to renegotiate the transmissions of such data.

Of note, as referenced above “seeding” refers to using the credentials of an end user as the starting point in an algorithm where the algorithm determines such items as determining different sized data packets, the number of data packets to send, how the data is assigned to the data packets, and with what encryption scheme (which includes an optional, random compression technique) are used to encrypt the data packets. More specifically, the credentials of a user are used as seeds to create multiple encryptor/decryptor code modules. The encryptor/decryptor code modules are created based on published Advanced Encryption Standard (AES) algorithms in which the AES algorithms are used to create code modules that can encrypt and/or decrypt a packet of data (chunks). Further, the code modules are generally two or more blocks of data (the “seeds”) that are used to modify how the encryptor/decryptor code module works so that only similarly configured encryptor/decryptor code module on each end can code and decode the data. In other words, both receiving and sending endpoint devices must use the same seeds or the data will be undecipherable. As the credentials of a user are known to both endpoint devices, the encrytpor/decryptor modules can match, as long as each end knows which one of the several modules to use for each data packet.

Further, a sending endpoint device (more specifically, program code of the data transfer module) can use the credentials of the user as well as other information unique to the endpoint device (such as, hardware serial numbers or other static information) to determine the number of chunks to send, the size of each chunk, the encryption to use (which helps the receiving endpoint device know how to decrypt and/or decompress the data) for each chunk, and the order the chunks will be sent. Further, the program code of the data transfer module on the sending endpoint device can send only a limited number of chunks at a time and will not send additional chunks before ensuring that chunks are properly received. In this way, only a limited number of chunks are in transit at any time

Of note, as described herein, a send pattern can be created based upon the credentials of a user. In further illustration of how a send pattern can be created, three randomly seeded pseudo-random number generators can be used to create a set of parameters from which a sending endpoint device can determine how to break up a particular data message into chunks, what compression and encryption to apply to each chunk, and in what order the chunks will be sent. Each pseudo-random number generator requires two seed string values. It is noted in the following example that the results depicted by the pseudo-random number generators and/or the results of the encryptors may not be the actual results of applying standard AES or other encryption to actual data. Further, an assumption is made that the encryptor used for each chunk is the same—AES 128 encryption, seeded with a name and password of a user as the two seed values.

More specifically, assuming there is a hundred (100) byte message to be sent, a send pattern can be created by first creating a set of offset and length pairs that ensure all hundred bytes will be sent. This, in one instance, can be accomplished by seeding a (first) pseudo-random number generator using two seeds, for instance seed1 can equal the password of the user (as a string) and seed2 can equal the number of microseconds past midnight, which is also represented as a string, such as 10000000 would represent ten (10) seconds past midnight. Upon seeding the pseudo-random number generator, numbers in the range of one through one-half of the remaining bytes unaccounted for are generated, unless the remaining number of bytes is twenty five (25) or less. So for example, if the random numbers are thirty (30), thirty five (35), and fifteen (15), a remainder of twenty (20) is left, thus the chunk offset and lengths will be as described in the figure below:

| Chunk | Offset (0- | Length in |
|---|---|---|
| number | based) | bytes |
| 0 | 0 | 30 |
| 1 | 30 | 35 |
| 2 | 65 | 15 |
| 3 | 80 | 20 |

Upon determining the chunk offset and lengths, the sequence of chunks to send can be created, which will be a random ordering of the four chunks. This can be accomplished, in one instance, by seeding a different (second) pseudo-random number generator with two seeds, where seed1 can equal the number of seconds since Jan. 1, 2000 at midnight (as a string) and seed2 can equal the password of the user (as a string). A table of four (4) random numbers ranging from one (1) to one million (1,000,000) can then be created.

| Random number | Random number index |
|---|---|
| 15 | 0 |
| 3 | 1 |
| 200 | 2 |
| 30 | 3 |

The random number table can then be sorted, so that the order of the chunks can be determined. Thus, as shown in the table below, the chunks will be sent in the order 1, 0, 3, 2. In other words chunk number 1 is sent first, followed by chunk number 0, then chunk number 3, and finally chunk number 2.

| | Original index = chunk |
|---|---|
| Random number | number to send |
| 3 | 1 |
| 15 | 0 |
| 30 | 3 |
| 200 | 2 |

In addition, the credentials of a user can also be used when compressing each packet of data. As illustrated here, the determination of the compression to be used can be integrated with the send pattern, but, in a different embodiment, the determination of the compression scheme to be use can be separately determined. By way of example, the method of compression to be used can be determined using a (third) pseudo-random number generator that is seeded with two seeds. For instance, seed1 can be formed by the combination of a username of a user, the password of the user, and the number of chunks (all combined to create a string input), and seed2 can be the machine serial number (or Media Access Control (MAC) address). Once the pseudo-random number generator is seeded, a table of four (4) random numbers (representing the total number of chunks) between one (1) and five (5) can be created, as seen in the table below. (The range of numbers, one (1) through five (5) here, represents the number of possible compression techniques.)

| | Random Compression |
|---|---|
| Chunk Number | technique |
| 0 | 4 |
| 1 | 4 |
| 2 | 1 |
| 3 | 5 |

The entire send pattern for the one hundred (100) byte message can then be compiled, as illustrated in the table below:

| Sequence | | | | |
|---|---|---|---|---|
| Number | Chunk Number | Offset | Length | Compression |
| 0 | 1 | 30 | 35 | 4 |
| 1 | 0 | 0 | 30 | 4 |
| 2 | 3 | 80 | 20 | 5 |
| 3 | 2 | 65 | 15 | 1 |

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having computer readable program code embodied therein.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by, or in connection with, an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied in a computer readable medium may be transmitted using any appropriate medium, including but not limited to, wireless, wireline, optical fiber cable, radiofrequency, and the like, or any suitable combination of the foregoing. Computer program code for carrying out operations for aspects of the present invention may be written in any combination of one or more programming languages, including an object oriented programming language and conventional procedural programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been described above with reference to flowchart illustrations and/or block diagrams of methods, apparatus (systems) and computer program products according to embodiments of the invention. In this regard, the flowchart and block diagrams in the Figures illustrate the architecture, functionality, and operation of possible implementations of systems, methods and computer program products according to various embodiments of the present invention. For instance, each block in the flowchart or block diagrams may represent a module, segment, or portion of code, which comprises one or more executable instructions for implementing the specified logical function(s). It should also be noted that, in some alternative implementations, the functions noted in the block might occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It also will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Finally, the terminology used herein is for the purpose of describing particular embodiments only and is not intended to be limiting of the invention. As used herein, the singular forms “a”, “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention in various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A secure data transfer method between endpoint devices, comprising:
determining a send pattern utilizing account credentials of a user, the send pattern defining a plurality of offset and length pairs;
creating packets of data according to the send pattern, each packet of data containing randomly assigned data of different sizes;
encrypting each packet of data to produce a set of encrypted packets of data; and,
sending the set of encrypted packets of data to a destination endpoint device in an order determined according to the account credentials.

2. The method of claim 1, wherein the send pattern further identifies a compression to be applied to each packet of data.

3. The method of claim 1, wherein the send pattern further defines the order the set of encrypted packets of data are sent to the destination endpoint device

4. A data processing system configured for processing data for transferring between endpoint devices, comprising:
a server with at least one processor and memory;
an originating endpoint device coupled to the server;
a destination endpoint device coupled to the server; and,
a data transfer module executing in memory of the originating endpoint device, the module comprising program code enabled to determine a send pattern utilizing account credentials of a user, the send pattern defining a plurality of offset and length pairs, to create packets of data according to the send pattern, each packet of data containing randomly assigned data of different sizes, to encrypt each packet of data to produce a set of encrypted packets of data, and to send the set of encrypted packets of data to the destination endpoint device in an order determined according to the account credentials.

5. The system of claim 4, wherein the send pattern further identifies a compression to be applied to each packet of data.

6. The system of claim 4, wherein the data transfer module is also executing in memory of the destination endpoint device.

7. The system of claim 4, wherein the send pattern further defines the order the set of encrypted packets of data are sent to the destination endpoint device.

8. A computer program product for transferring data between endpoint devices, the computer program product comprising:
a computer readable storage medium having computer readable program code embodied therewith, the computer readable program code comprising:
computer readable program code for determining a send pattern utilizing account credentials of a user, the send pattern defining a plurality of offset and length pairs;
computer readable program code for creating packets of data according to the send pattern, each packet of data containing randomly assigned data of different sizes;
computer readable program code for encrypting each packet of data to produce a set of encrypted packets of data; and,
computer readable program code for sending the set of encrypted packets of data to a destination endpoint device in an order determined according to the account credentials.

9. The computer program product of claim 8, wherein the send pattern further identifies a compression to be applied to each packet of data.

10. The computer program product of claim 8, wherein the send pattern further defines the order the set of encrypted packets of data are sent to the destination endpoint device.

11. A secure data transfer method between endpoint devices, comprising:
receiving a set of encrypted packets of data from an originating endpoint device in an order determined according to account credentials of a user, each encrypted packet of data containing randomly assigned data of different sizes;
decrypting the set of encrypted packets of data using the account credentials of the user to produce a set of decrypted packets of data; and,
reassembling the set of decrypted packets of data to form a data message according to a send pattern utilizing account credentials of the user, the send pattern defining a plurality of offset and length pairs.

12. The method of claim 11, further comprising decompressing the set of decrypted packets of data.

13. A data processing system configured for receiving data between endpoint devices, comprising:
a server with at least one processor and memory;
a destination endpoint device coupled to the server;
an originating endpoint device coupled to the server; and,
a data transfer module executing in memory of the destination endpoint device, the module comprising program code enabled to receive a set of encrypted packets of data from the originating endpoint device in an order determined according to account credentials of a user, each encrypted packet of data containing randomly assigned data of different sizes, to decrypt the set of encrypted packets of data using the account credentials of the user to produce a set of decrypted packets of data, and to reassemble the set of decrypted packets of data to form a data message according to a send pattern utilizing account credentials of the user, the send pattern defining a plurality of offset and length pairs.

14. The system of claim 13, wherein the program code of the data transfer module is further enabled to decompress the set of decrypted packets of data.

15. The system of claim 13, wherein the data transfer module is also executing in memory of the originating endpoint device.

16. A computer program product for transferring data between endpoint devices, the computer program product comprising:
a computer readable storage medium having computer readable program code embodied therewith, the computer readable program code comprising:
computer readable program code for receiving a set of encrypted packets of data from an originating endpoint device in an order determined according to account credentials of a user, each encrypted packet of data containing randomly assigned data of different sizes;
computer readable program code for decrypting the set of encrypted packets of data using the account credentials of the user to produce a set of decrypted packets of data; and,
computer readable program code for reassembling the set of decrypted packets of data to form a data message according to a send pattern utilizing account credentials of the user, the send pattern defining a plurality of offset and length pairs.

17. The computer program product of claim 16, further comprises computer readable program code for decompressing the set of decrypted packets of data.
